(19) United States
(12) Patent Application Publication
(10) Pub. No.: US 2013/0069967 A1
(43) Pub. Date: Mar. 21, 2013

(54) Methods And Apparatus For Creating A Visual Language For Diagrams

(71) Applicants: Ateret Anaby-Tavor, Givat Ada (IL); David Amid, Kiryat Ata (IL); Matthew J. Callery, Shrub Oak, NY (US); Michael Desmond, White Plains, NY (US); Sophia Krasikov, Katonah, NY (US); Harold L. Ossher, Salem, NY (US); Ian D. Simmonds, Dobbs Ferry, NY (US)

(72) Inventors: Ateret Anaby-Tavor, Givat Ada (IL); David Amid, Kiryat Ata (IL); Matthew J. Callery, Shrub Oak, NY (US); Michael Desmond, White Plains, NY (US); Sophia Krasikov, Katonah, NY (US); Harold L. Ossher, Salem, NY (US); Ian D. Simmonds, Dobbs Ferry, NY (US)

(73) Assignee: International Business Machines Corporation, Armonk, NY (US)

(21) Appl. No.: 13/236,911

(22) Filed: Sep. 20, 2011

(51) Int. Cl. G06T 11/00

(52) U.S. Cl. 345/581

(57) ABSTRACT

Improved systems and techniques for representation of information. As a user creates a graphic design, properties represented by graphical elements of the design, are associated with visual characteristics of the elements, and a palette of elements is made available for use in development of the design or creation of new designs. As generalized elements are added to a design, the generalized elements may take on visual characteristics associated with properties identified by the positioning of the generalized elements in the design. Ongoing or existing designs may be surveyed to identify elements, properties represented by the elements, and visual characteristics associated with the properties, and new elements added to the palette or existing elements modified as a result of one or more surveys.

### FIELD OF THE INVENTION

The present invention relates generally to graphical representation. More particularly, the invention relates to mechanisms for developing graphical tools.

### BACKGROUND

The latter part of the twentieth century and the early part of the twenty-first century have seen exponential increases in the generation and distribution of information. Pictorial representation has always been a particularly convenient way to present information. Pictures can be used to convey important elements of information in a way that can be rapidly understood by a recipient. As data processing equipment has become more widespread and more powerful, more numerous and accessible graphical tools have been developed, increasing the ability of users to create pictorial structures and representations.

In typical prior art systems, a drawing or design package includes a set of tools defined more or less as a unit by a developer of the package, or by some designer who provides a tool set to be used with the package. Such sets of tools may only imperfectly meet the needs of a particular user, but the average user may lack the technical ability to create a tool set customized to his or her needs, or may not wish to devote the time required to create a customized tool set.

### BRIEF SUMMARY

In one embodiment of the invention, a method comprises configuring at least one processor to perform the functions of receiving inputs from a user as the user creates one or more graphical elements representing one or more properties, identifying one or more visual characteristics of the graphical elements and one or more properties represented by the graphical elements, and storing information identifying one or more visual characteristics and one or more properties of the graphical elements.

In another embodiment of the invention, an apparatus comprises at least one processor and a memory storing a program of instructions. The instructions, when executed by the processor, configure the apparatus to receive inputs from a user as the user constructs two or more graphical elements, identify common properties shared between one or more of the graphical elements, and assign similar visual characteristics to different graphical elements. Similar visual characteristics are used for the different graphical elements to indicate common properties illustrated by the different elements.

In another embodiment of the invention, a computer readable memory stores a program of instructions. Execution of the program of instructions by a processor configures an apparatus to perform at least the functions of receiving inputs from a user as the user constructs one or more graphical elements, identifying common properties shared between two or more of the visual elements, and assigning similar visual characteristics to different graphical elements. Similar visual characteristics are used for different graphical elements to indicate common properties shared by the different graphical elements.

These and other embodiments and aspects are detailed below with particularity.

### BRIEF DESCRIPTION OF THE SEVERAL VIEWS OF THE DRAWINGS

FIG. 1 illustrates a diagram that may be created using mechanisms according to an embodiment of the present invention;

FIG. 2 illustrates a system implementing an embodiment of the present invention;

FIG. 3 illustrates details of a system according to an embodiment of the present invention;

FIGS. 4A-4C illustrate aspects of a diagram created in an environment according to an embodiment of the present invention; and

FIG. 5 illustrates a process according to an embodiment of the present invention.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present invention recognize a need to provide accessible tools allowing users to customize, or even to create, their own mechanisms for graphical representation. One key to accessibility is automation—an accurate recognition of what the user is trying to do and appropriate response to such recognition. Another key to accessibility is generalization. Generalization allows for the undertaking of specific activities and identification of elements of those activities as applicable to other, related uses. For example, a particular graphical element may be created during construction of a presentation. A graphical element may comprise an element directed primarily toward visual representation of information, such as pictures, lines, shapes, and the like, and contrasts with conveyance of information primarily through text.

Generalization allows for assignment of the graphical element to a category of related elements, and it also allows for propagation of characteristics of the graphical element to other related elements. Generalizations may be broader or narrower, and may be used in combination. For example, in spoken language, various parts of speech may be used in combination, such as in a combination of subject-verb-object. Similarly, in a set of graphical elements, some elements may represent actors and things or persons acted upon, and elements may include characteristics indicating their relationship to other elements. For example, an element may have a particular color to indicate that it is associated with a particular person and a particular shape to indicate that it represents the person is taking an action. Another element may have a different color to indicate that it is associated with a different person, and a particular shape to indicate that the person is a recipient of the action. In embodiments of the present invention, as will be seen below, such categorizations can grow and develop based on the construction of individual elements. That is, a user may construct a particular graphical representation. During the construction, the mechanisms used in the construction, or associated mechanisms, may examine the choices made by the user and automatically assign categories and characteristics to elements of the representation and may also suggest such categories and characteristics to the user for selection. Alternatively or in addition, the user may define characteristics of elements that are selected or created, and such characteristics may be propagated to elements in the same category, whether these categories are user defined or automatically generated.

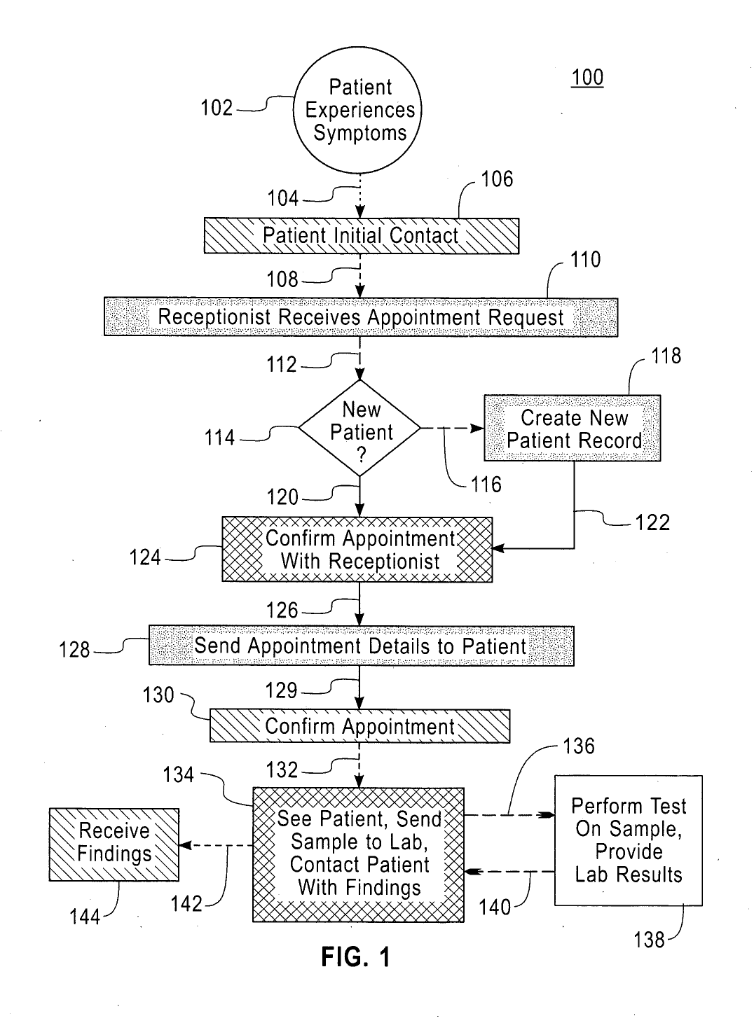

FIG. 1 illustrates a diagram 100 serving as an example of a graphical representation that may be produced using one or more embodiments of the present invention. In addition, the actions taken in designing the diagram 100 may inform the development of a visual language that can be used in the development of subsequent diagrams and other graphical representations.

The diagram 100 comprises blocks representing actions by specifically identified parties that are taking actions associated with their roles with respect to an organization. The diagram 100 comprises blocks of particular colors and shapes, with various ones of the blocks also containing text identifying specific parties or actions. In the particular example shown, the diagram 100 presents a representation of an activity involving the treatment of a patient at a doctor's office. The office receives a request for an appointment and makes the appointment. The doctor sees the patient and then contacts an external provider for lab work. The doctor receives the lab report and contacts the patient with the results.

In the present example, the blocks are used to represent activities, with the color of each block being used to designate the classification of the party involved in the action. The block contains text identifying the action, and may also contain text identifying the party. Connectors between the blocks are shaped so as to identify the nature of the action taken, such as a patient contact, internal contact within the office, or contact between the office and an outside service provider. As described in greater detail below, the various elements of the diagram may be taken from a library that can change and evolve both automatically based on analysis of their use and through direct user selections.

The circle 102 represents an initial event experienced by the patient, namely, the experience of symptoms. A connector 104 provides a connection to the block 106, which indicates an action taken by the patient. The connector 104 is chosen to indicate the general nature of the connection between the event specified by the block 102 and the event specified by the block 106. The connection in this case is an action by the patient in response to an experience of an event. The block 106 indicates a contact by the patient with the doctor's office, with a connector 108 chosen to indicate, from the perspective of the doctor's office, an external contact. The block 110 indicates an action by the receptionist, namely, to receive the appointment request, and the connector 112 leads to a block 114, which is a decision block indicating different actions to be taken depending on whether the patient is a new patient or not. The blocks 118 and 128 indicate additional receptionist actions, the blocks 124 and 134 represent doctor actions, the blocks 130 and 144 represent additional patient actions, and the block 138 represents action by an outside lab. In the present example, the different blocks are assigned colors to indicate the actors they represent, and the various connectors 104, 108, 112, 122, 126, 129, 132, 136, 140, and 142 have different appearances to indicate the types of connections they represent. For example, the connector 104 has one appearance to indicate that it represents a connection between an event experienced by the patient and a patient action, the connector 108 has another appearance to indicate that it represents a contact between the office and a patient, the connector 112 has another appearance to indicate that it connects actions by the same person within the office, the connector 122 has still another appearance to indicate that it represents an internal contact within the office, and the connectors 136 and 138 have another appearance to indicate that they represent a contact between the office and an outside provider.

The various component of the diagram 100, and the diagram 100 as a whole, exhibit a number of characteristics, and the design choices made by a user may be observed during the creation of the diagram 100 by automated equipment and tools used in creating the diagram 100. In particular, shared properties may be observed and elements provided by a palette of available elements may be automatically configured to exhibit characteristics reflecting these properties. In addition, elements may be explicitly added to the palette and the added elements may be specifically designated by a user as associated with particular properties, with particular characteristics designated as reflecting those properties.

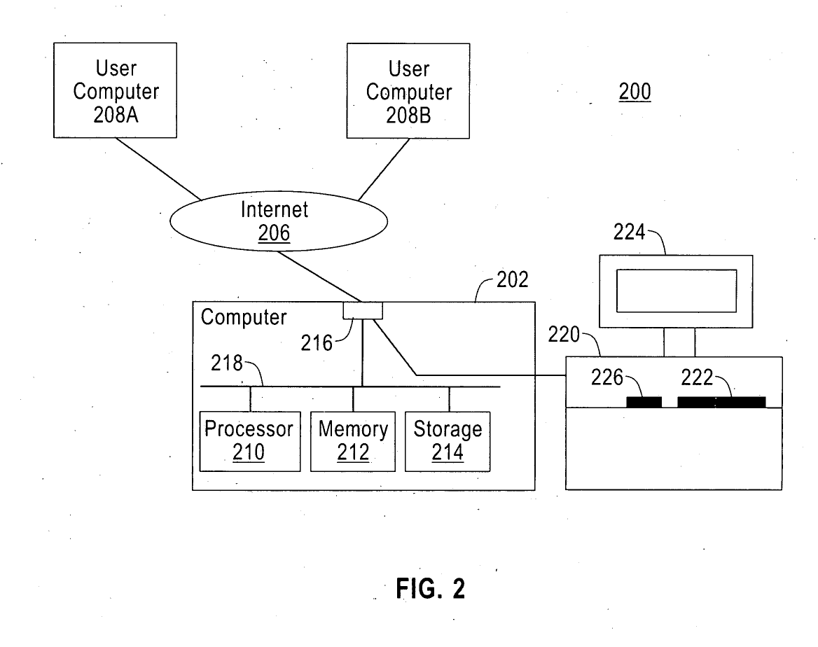

FIG. 2 illustrates a system 200 that may be used in the practice of one or more embodiments of the invention. The system comprises a computer 202, which may suitably be a central server accessible to users through the public Internet 206. Various user computers such as the computers 208A and 208B may be used to gain access to the services provided by the computer 202. The computer 202 may suitably comprise a processor 210, memory 212, and storage 214, as well as communication port 216, all communicating over a bus 218. The computer 202 may suitably comprise a user interface 220, including a keyboard 222, monitor 224, and pointing device, although it will be recognized that the computer 202 may be implemented as a server accessible through other computers, and may operate without a user interface. The computers 208A and 208B may include similar hardware components to those of the computer 202.

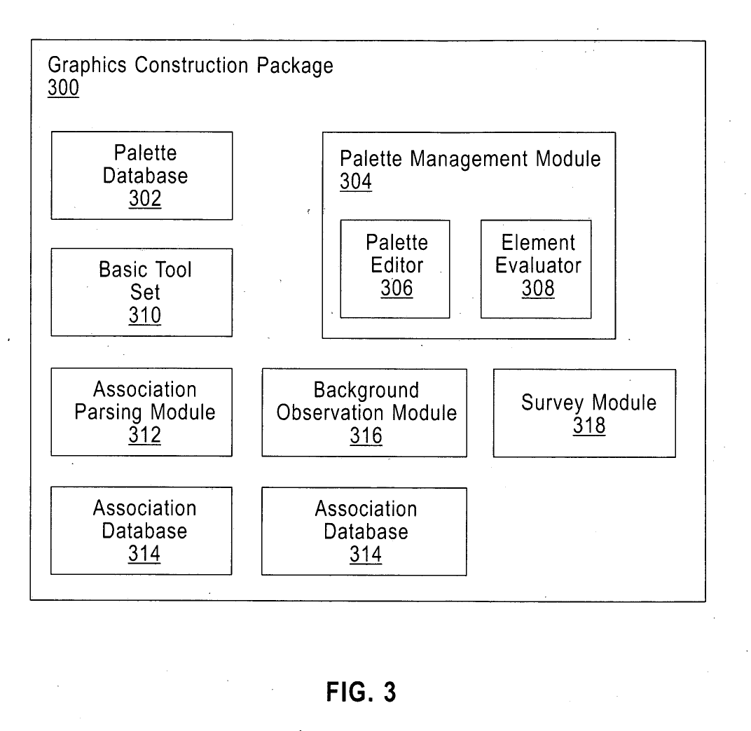

FIG. 3 illustrates details of a graphics construction package 300, suitably implemented by one or more of the computers of the system 200, such as the computer 202, where it may be implemented as software residing in storage 214 and transferred to memory 212 as needed for execution by the processor 214. The graphics construction package 300 suitably implements a palette database 302, which may suitably store constructed elements that provide a relatively complete representation, including characteristics associated with properties of the person, thing, or activity being represented. While a database 302 is illustrated here, it will be recognized that any storage mechanism may be employed.

As an example of the characteristics associated with the properties being represented, the connectors illustrated in FIG. 1 have different appearances to indicate whether they reflect internal contacts, contacts with patients, or contacts with outside providers. Similarly, the boxes illustrated in FIG. 1 have different colors to indicate which party is associated with the activities they represent. The palette database 302 stores elements that are to be made available for use in a design or project, and may include elements that have been specifically added to the palette database 302 by user selection, and may also or alternatively include elements that have been developed by a user working on a project and automatically added to the palette database 302. The graphics construction package 300 suitably comprises a palette management module 304. The palette management module 304 monitors the development of elements that may be added to the palette database 302, and provides a palette editor 306 and an element evaluator 308. The palette editor 306 provides a user interface, allowing a user to develop elements and specifically add those elements to the palette database 302, and also allows a user to retrieve elements already belonging to the palette database 302 and make modifications to those elements.

The palette management module 304 also examines elements as they are being created and determines if an element should be automatically added to the palette database 302. Such determinations may be made based on associations between an element and properties to be represented, and such associations may be identified through any number of mechanisms, such as similarity to elements used in already created designs, explicit user designation, and other mechanisms.

The graphics construction package 300 may also implement a basic tool set 310, providing mechanisms for creation of basic shapes, lines, connectors, and the like, as well as mechanisms for modifying basic shapes and creating designs from scratch. In addition, the graphics construction package may implement an association parsing module 312 for associating properties with various activities and contacts. The association parsing module 312 may create or suggest associations based on its observation of use of various elements in a graphical representation, or may receive specific designations of properties from a user. Graphical elements may then be given characteristics associated with their properties. Often, what is important is not that particular characteristics be associated with particular properties, but that the characteristics of elements differ when the elements represent different properties. Therefore, in one embodiment, the association parsing module 312 assigns particular categories of characteristics to elements and assigns a specific characteristic within a category to an element based on the property associated with the element, with the characteristic being chosen at random. For example, a block element might be associated with a color and a connector element might be associated with a drawing style, such as a solid or dashed line. When the association parsing module 312 detected that an element being created had a property differing from those previously used, it might randomly select a previously unused characteristic by some appropriate mechanism. For example, in the example presented in FIG. 1, a user might create an activity associated with a governmental authority. The association parsing module 312 would recognize that the activity was associated with a new property and randomly choose a previously unused color for the activity. Alternatively, the association parsing module 108 might suggest a randomly selected color to a user and allow the user to confirm or alter the selection. In one embodiment, the association parsing module 312 provides mechanisms for a user to change characteristics associated with properties at any time, or to designate characteristics to be associated with properties.

One convenient way to associate characteristics with an element is through the use of tags. Therefore, in one embodiment, the graphics construction package 300 stores an association database 314 that uses tags to indicate various properties. Tags may be ordinary words that have meaning to a user and can be manually added by a user.

The association database 314 may be constructed or refined as each project is developed, and tags developed for one project may remain in the association database 314, with the tags and their associations being used to inform the graphics construction package 318 during work on subsequent projects in the same category.

The association database 314 may include records associating tags with properties, activities, persons, graphical elements, and graphical element characteristics. Thus, for example, the tag “internal” may appear in a number of records. For example, consider the record below. The record defines representations of a doctor as the doctor appears in graphical elements relating to internal activities and communications within the office. Therefore, the record appears as follows:

| TAG | ELEMENT | CHARACTERISTIC |
|---|---|---|
| DOCTOR | BLOCK | ORANGE |

Another record might relate to an interaction between the doctor and the receptionist, and might appear as follows:

| TAG | ELEMENT | CHARACTERISTIC |
|---|---|---|
| INTERNAL | CONNECTOR | SOLID WITH |
| | | CLOSED ARROW |

As associations are developed, through analysis by the association parsing module or through explicit designation by a user, additional records may be created defining the associations. For example, a record might be created associating the “INTERNAL” tag with doctor-receptionist interactions, and might appear as follows:

| TAG | INTERACTION |
|---|---|
| INTERNAL | DOCTOR- |
| | RECEPTIONIST |

Once this record has been created, association parsing module 312 can use it to automatically assign appropriate characteristics to elements. Suppose, for example, that a user has selected and positioned blocks designating the doctor and receptionist, and wishes to show an interaction between them. To take one example, the user may select the interaction by dragging a connector into place. The connector may appear on a palette of available elements. Because doctor-receptionist interactions have been designated as “internal”, there is no need for a multitude of different connectors to appear on the palette, with varying characteristics indicating the nature of the interactions they represent. Instead, the association parsing module 312 will examine the association database 314 and recognize that the interaction is an internal interaction and that the connector for such interactions is to be represented as a solid line with a closed arrow, and automatically cause the connector to take on the correct characteristics once the connector has been put in place.

In addition, the graphics construction package 300 presents the capability for a user to create graphical elements from scratch, or to modify existing graphical elements. A user may, for example, use the basic tool set 310 to create elements, and these elements may be examined for commonality with existing elements. In addition, newly designed elements, or existing elements, may be placed in a design, and characteristics such as the position and orientation of an element, or its relation to other elements in the design, may be examined for commonality with previously created elements or standard elements, and properties may be associated with the element and with one or more of its characteristics as used in the design. Thus, for example, if a user creates a first block and colors the block yellow, and creates a second block and colors the block orange, the association parsing module 312 can review the association database 314 to identify the properties associated with yellow and orange blocks. The association parsing module 312 will be able to identify the yellow block as representing the doctor and the orange block as representing the receptionist. As the user places the blocks and performs additional actions, such as adding connectors or orienting the blocks, the association parsing module 312 may recognize relationships between previously used combinations and may update the association database 314 to associate the combination with the relationship indicated by the arrangement of the blocks. The association parsing module 312 may deliver the newly identified relationship to the palette management module 304, which may then update the palette database 302. For example, in addition to presenting the individual elements, the palette database 302 may, once the new associations have been identified and updated, present the elements in the identified combinations or arrangements.

In addition to providing its own graphical tools in the tool set 310 and analyzing designs created by a user with those tools, the graphics construction package may also analyze designs created using other drawing tools and drawing packages. In one embodiment of the invention, the graphics construction package 300 may provide a background observation module 316 that may, upon activation, reside in the background of a user computer or a network in such a way that it is able to detect the user's activities with a drawing package. Numerous drawing packages are available, and some drawing packages use formats shared among multiple drawing packages produced by different manufacturers, while others at least use formats shared among designs created by the drawing package itself or drawing packages created by the same manufacturer. The background observation module 316 may be adapted to detect and identify elements such as lines, shapes, curves, and the like, as well as characteristics such as line thickness, element color, dimensions, placement, and other characteristics. The background observation module 316 may observe and interpret designs and elements created using any drawing package with which it has been adapted to operate, and may populate the palette database 302 with elements created using one drawing package or another that happens to be employed by the user. All of the elements available on the palette database 302, however created, may be available for use with the graphics construction package 300. The palette manager 304 may suitably add elements to the palette database 302 in the format used by the graphics construction package 300 or, in other embodiments of the invention, in a standardized intermediate format that such that the elements retrieved from the palette database 302 can be automatically adapted for use with a particular drawing package employed by the user. If such an intermediate format is used, it is a relatively simple matter to make the palette database 302 available across drawing platforms, and the palette manager 304 may reside in the background of a user's computer or a network available to a plurality of users and convert elements from the intermediate format to a format adapted to a particular user's drawing platform as that user retrieves the elements from the palette database 302.

In addition to providing the background observation module 316, the graphics construction package 300 may also provide a survey module 318. This survey module 318 may be invoked whenever desired and may examine stored designs produced by the user and designs produced by others and accessible to the user. The survey module 318 may suitably be able to be limited in its operation to survey designs dealing with similar subject matter. For example, in the doctor's office discussed above, designs dealing with the various functions of the office are suitable candidates for examination because they can be expected to exhibit commonalities. Other designs, produced by different organizations, or by divisions of the same organization, may also be suitable candidates for examination if they can be expected to include sufficiently similar subject matter or to represent items and properties in a sufficiently similar way.

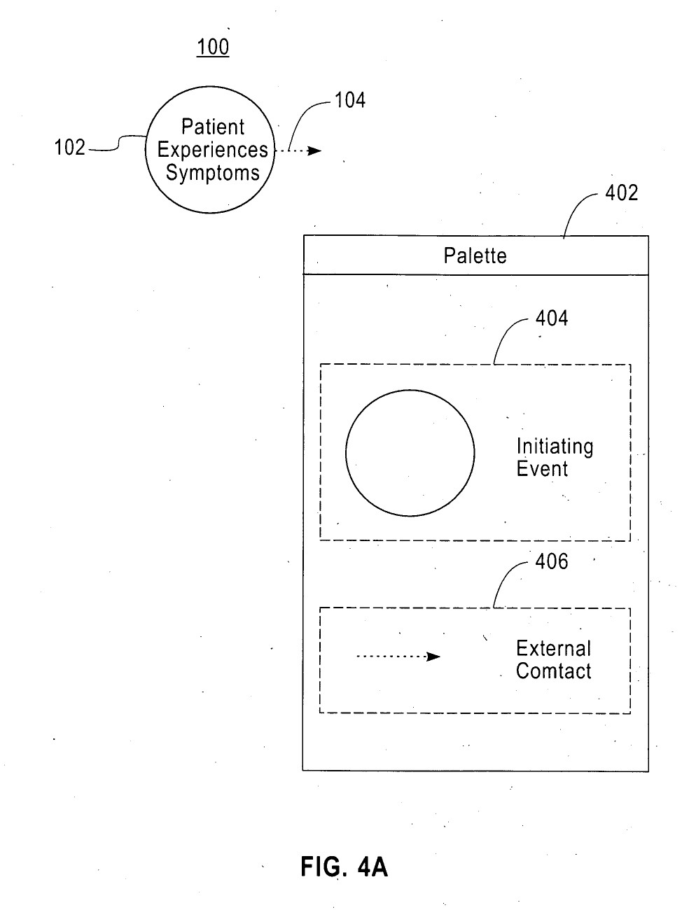

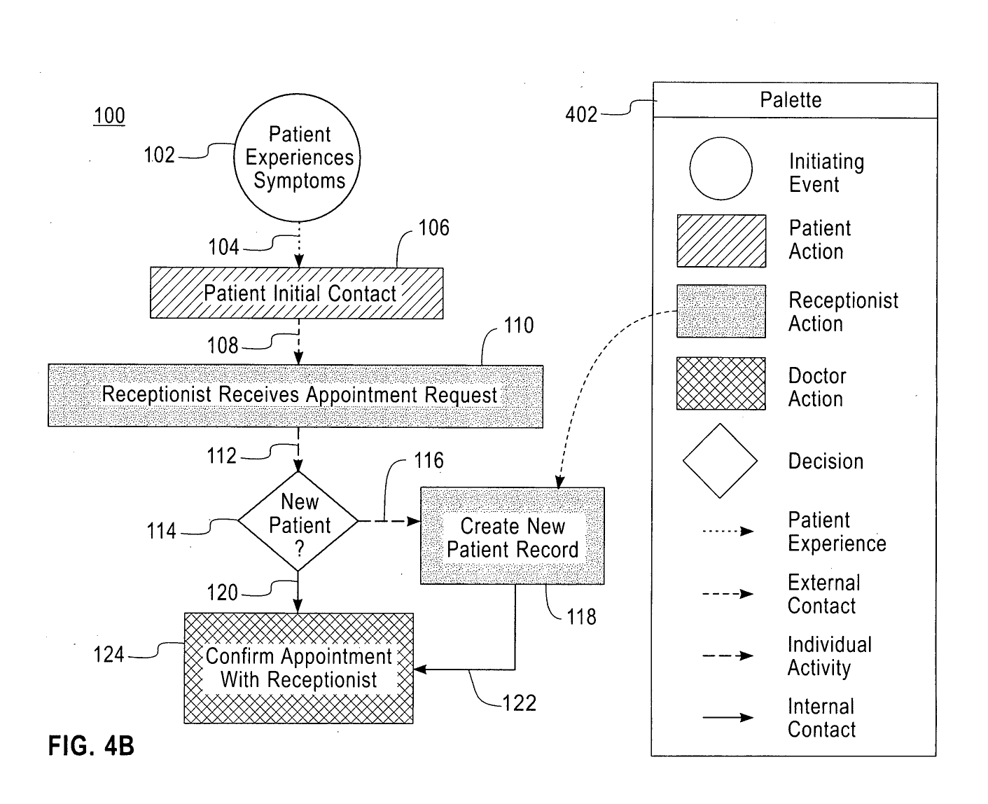

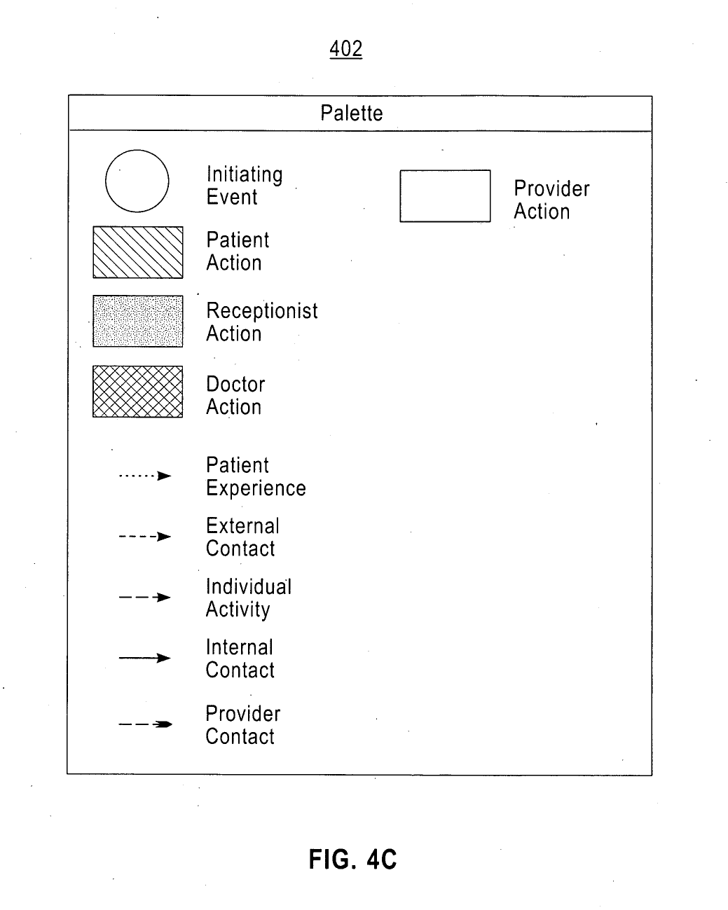

FIGS. 4A-4C illustrate stages of development of the diagram 100, as they are accomplished through the use of a system such as the system 200 of FIG. 2 employing a graphics construction package such as the package 300 of FIG. 3. In the present example, the diagram 100 represents an initial project along the lines presented, so that a palette 402 associated with the project is initially blank. As the diagram 100 is developed, commonalities are identified and elements added to a palette associated with the project. The palette 402 may be specifically associated with the particular project, may be associated with projects of the same type, or may more generally defined so that elements take from the palette 402 may be used in a variety of projects and elements developed during creation of a variety of projects may be presented in the palette 402. The palette database 302 illustrated in FIG. 3 may be used to store information relating to objects included in the palette, with changes to objects being reflected in the information stored in the database 302, and with information being retrieved from the database 302 to allow for the placement in a project or design of an object taken from the palette 402.

FIG. 4A illustrates the diagram 100 after placement of the elements 102 and 104, representing a patient's experience of symptoms and a patient's contact with the doctor's office. In the context of the description being developed, these occurrences may be generalized to an initiating event and an external contact. Properties associated with these events may be identified by the association parsing module 312, which in the present initial example may suitably receive explicit designations from a user, but it will be recognized that the association parsing module 312 may provide a designation to any element added, or suggested for addition, to the palette 402, and that a user will be free to edit or remove such designations at any time. Specific characteristics associated with the elements may be identified or designated, and appropriate palette elements 404 and 406 are added to the palette 402. It will be seen that the palette element 404 does not include a label because its general properties, not its specific application in a particular instance, are relevant in the context of the palette 402.

FIG. 4B illustrates the diagram 100 after placement of the additional elements 106-124, as well as the palette 402, which is shown in a further stage of development. As each of the elements is placed, the state of the project and the relationships between elements is evaluated by the association parsing module 312 and a determination is made as to whether a new element is to be added to the palette 402. The evaluation may depend, for example, on whether the element represents a new property, or whether the element is unique, in which case it may be unnecessary or undesirable to add it to the palette. At any time, a user may explicitly add an element to the palette, along with definitions, links and associations with other elements, and the association parsing module 312 may add appropriate descriptors and tags to the association database 314 in order to maintain appropriate links between elements and properties and characteristics of elements so that common properties shared across elements are reflected in common characteristics. The user may also change characteristics of an element. For example, the element indicating a patient action, such as the specific patient initial contact 106 and the generalized element relating to patient action that appears in the palette 402, is blue, but a user may change the color of a specific element at any time. A user may designate a change as relating to one element or may allow the change to ripple through the palette 402 and some or all uses of the element in a single diagram or in diagrams drawing from the same palette.

It can be seen that one of the elements appearing in the diagram as it appears in FIG. 4B—that is, the element 118—has been taken from the palette 402 and placed in the diagram. The elements appearing in the palette 402 are available for placement in the diagram at any time. In the present example, a user has dragged an element from the palette 402 to a position in the diagram, and completed details so that it appears as the element 118. Once the element 110 was created, its properties and characteristics were stored in the palette database 302, and its associations were identified by the association parsing module 312. A generalized representation of the properties and characteristics of the element 110 was then placed into the palette 402, and was made available for use.

FIG. 4C illustrates the palette 400, as it appears after completion of the diagram 100. The palette illustrates the addition of a new element, indicating a provider action, and a new connector, indicating a contact with a provider.

It will be recognized that various restrictions may be desirable on placement of various elements or arrangements of elements in a diagram. For example, a connector indicating an internal contact or a provider contact should not be usable with a patient action. Therefore, appropriate constraints may suitably be associated with various elements. Creation of constraints and their associations with elements of a diagram may be performed or proposed by appropriate components of the graphics construction package 300. For example, the association parsing module 312 may observe elements as they are placed to determine the associations that are used, and the survey module 318 may examine a number of projects to determine the associations that are used over multiple projects. If, for example, a module examining the construction of one or more projects notes that a particular connector is not used with a particular action, a query may be presented to the user, allowing the user to impose constraints on elements or sets of elements. Thus, the connector indicating an internal contact may be associated with a constraint preventing its use in connection with a contact with a patient. The constraint may be automatically imposed, specifically designated by the user, or affirmed by the user in response to a suggestion from a module observing the uses of various elements, such as the palette management module 304, the background observation module 316, or the survey module 318.

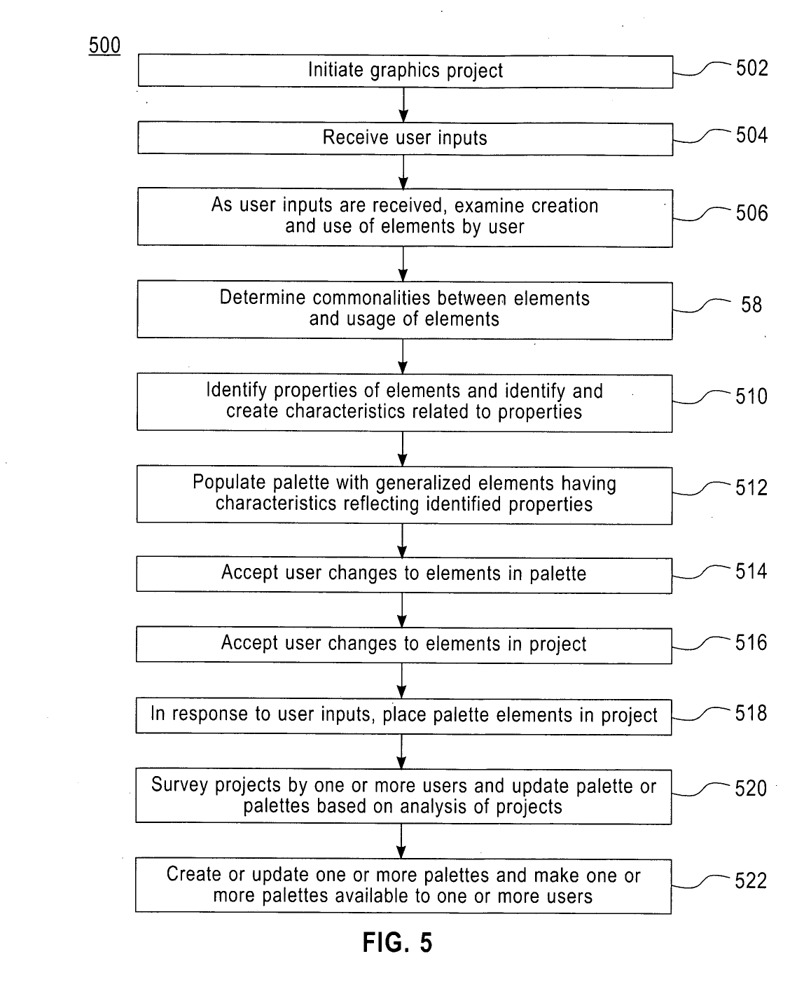

FIG. 5 illustrates a process 500 according to an embodiment of the present invention. The process 500 may suitably be implemented using a system such as the system 200 of FIG. 2, which may implement software such as the graphics construction package 300. At step 502, a graphics project is initiated. Initiation of the graphics project may suitably comprise presentation of a user interface, including a set of drawing tools, and the initiation of appropriate entities to observe user actions as elements are created and used and to analyze properties of elements and relationships between elements. At step 504, user inputs are received. At step 506, as user inputs are received, the creation and use of elements is observed. At step 508, commonalities between elements and relationships between elements are analyzed. At step 510, properties of elements are identified, and visual characteristics relating to properties and relationships of elements are identified. Identification may be automatic, through observation of usage, may be explicit, such as through user inputs, or may combine explicit and automated identification, such as through the creation by a user of a connector between a pair of elements, where the connector has particular visual characteristics, and recognition that a connector between a similar pair of elements should have similar visual characteristics. At step 512, as the process of receiving user inputs, determining commonalities, and identification and creation of visual characteristics proceeds, a palette is populated of generalized elements having visual characteristics reflecting identified properties. At step 514, user changes to elements in the palette are accepted as they are received, and such changes may be carried over to elements in a project under creation. For example, if a block indicating an action by a particular actor is colored pink in the palette and in a project, and the user changes the color of such a block to white, the color of the block as it appears in the palette may be changed to white, with the block appearing white in the future as it is taken from the palette and placed in a project. In addition, depending on user preferences, which may be indicated at appropriate times, such as at configuration of a graphics package, at initiation of a project, or at a change of an element in the palette, the change to the element may be carried through to the project under development, or may, if desired, be carried through to completed projects.

At step 516, user changes to elements in a project are accepted as they are received, and such changes may be carried over to elements in the palette and may also be carried over to existing projects, again, according to user preferences. At step 518, as user inputs are received, elements from the palette are placed in desired locations in a project. As the elements are placed, they may take on visual characteristics automatically based on the properties of the information they represent and their placement in relationship to other elements. At step 520, at appropriate times, projects by one or more users may be surveyed across a system, such as an individual workstation, a network, or a distributed group of users. At step 522, one or more palettes are created or updated based on the properties and visual characteristics of elements and the usage of elements identified by the survey, and these palettes may be made available to one or more users.

### Advantages of the Invention

Various embodiments of the present invention improve over the prior art by providing for mechanisms to identify commonalities between graphical elements, such as elements of a chart or diagram and relationships between graphical elements as indicated by their placement and use. Embodiments of the present invention further provide mechanisms to assign visual characteristics to elements based on detection of such commonalities and relationships—for example, recognizing a user selection of a visual characteristic for an element being placed in a diagram and further recognizing that the visual characteristic chosen by the user for the element should be assigned to other elements representing the same activities or possessing the same properties. Embodiments of the invention further provide for the creation of a palette of generalized elements available for placement in a graphics project, such as a chart or diagram. Embodiments of the invention further provide for such palettes to be made available for use in multiple projects and to different users, as well as the assembly of palettes using elements created by multiple projects and by one or more of multiple users.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

1. A method comprising:
configuring at least one processor to perform the functions of;
receiving inputs from a user as the user creates one or more graphical elements representing one or more properties;
associating one or more visual characteristics of the graphical elements and one or more properties represented by the graphical elements; and
storing information identifying the association between the one or more visual characteristics and the one or more properties of the graphical elements.

2. The method of claim 1, wherein the functions further comprise:
receiving further inputs from one or more users as the one or more users create further graphical elements;
identifying common properties shared between two or more of the graphical elements; and
assigning similar visual characteristics to different graphical elements, with similar visual characteristics being used for graphical elements to indicate common properties shared by the different graphical elements.

3. The method of claim 2, wherein the functions further comprise:
creating at least one generalized graphical element illustrating one or more properties and possessing visual characteristics associated with the properties being illustrated, and making the generalized graphical element available for use in a graphic design.

4. The method of claim 3, wherein making the generalized graphical element available for use in a graphic design comprises receiving user inputs directing placement of the generalized graphical element in a graphic design being created by the user and placing the generalized graphical element in accordance with the user inputs.

5. The method of claim 4, wherein the functions further comprise assigning to the generalized graphical element at least one additional visual characteristic based on its position in the graphic design.

6. The method of claim 2, wherein the functions further comprise receiving inputs from the user explicitly assigning at least one visual characteristic to a graphical element and assigning a similar or identical visual characteristic to other graphical elements illustrating similar properties.

7. The method of claim 1, wherein the functions further comprise creating a palette of generalized graphical elements available for placement in a graphic design, with new graphical elements being added to the palette as graphical elements illustrating new properties are identified in one or more graphic designs that are currently existing or in the process of being created.

8. The method of claim 7, wherein adding new graphical elements to the palette comprises surveying a plurality of existing graphic designs, identifying common properties and characteristics shared between multiple graphic designs, and populating the palette with one or more graphical elements possessing visual characteristics associated with common properties shared between graphical elements in multiple graphic designs.

9. The method of claim 5, wherein the visual characteristics that may be assigned to a generalized graphical element based on its position in a graphic design are limited based on constraints associated with the generalized graphical element.

10. The method of claim 9, wherein the constraints are based on observed uses of the generalized graphical element in relation to other graphical elements.

11. The method of claim 9, wherein the constraints are based at least in part of user inputs directing association of one or more constraints with the generalized graphical element.

12. The method of claim 2, wherein assigning similar visual characteristics to different graphical elements comprises receiving user inputs changing one or more visual characteristics assigned to one graphical element and making a similar change to the visual characteristics assigned to different graphical elements illustrating common properties shared with the changed graphical element.

13. The method of claim 7, wherein a change to the visual characteristics of a generalized graphical element in the palette is reflected in a similar change in the visual characteristics of the generalized graphical element as it appears in one or more graphic designs in which it has previously been placed.

14. The method of claim 7, wherein a change to the visual characteristics of a generalized graphical element appearing a graphic design is reflected in a change to the visual characteristics of the graphical element as it appears in the palette.

15. An apparatus comprising:
at least one processor;
a memory storing a program of instructions which, when executed by the processor, configure the apparatus to;
receive inputs from a user as the user constructs at least two graphical elements;
identify common properties shared between two or more of the graphical elements; and
assign similar visual characteristics to different graphical elements, with similar visual characteristics being used for different graphical elements to indicate common properties shared by the different graphical elements.

16. The apparatus of claim 15, further comprising an interface allowing access to a plurality of users, and wherein identifying common properties shared between two or more of the graphical elements comprises identifying common properties shared between two or more graphical elements created by different users.

17. The apparatus of claim 16, wherein the apparatus is further configured to creating a palette of generalized graphical elements available for placement in a graphic design, with new graphical elements being added to the palette as graphical elements illustrating new properties are identified in one or more graphical designs that are currently existing or in the process of being created, wherein the apparatus is configured to receive inputs from multiple users as the multiple users create multiple graphics projects and to add generalized graphical elements to the palette based on inputs from one or more of the multiple users.

18. A computer readable memory storing a program of instructions, execution of which by a processor configures an apparatus to perform at least the functions of:
receiving inputs from a user as the user constructs at least two graphical elements;
identifying common properties shared between two or more of the graphical elements; and
assigning similar visual characteristics to different graphical elements, with similar visual characteristics being used for different graphical elements to indicate common properties shared by the different graphical elements.

19. The computer readable memory of claim 18, wherein the functions further comprise creating at least one generalized graphical element illustrating one or more properties and possessing visual characteristics associated with the properties being generated, and making the generalized graphical element available for use in a graphic design.

20. The computer readable memory of claim 19, wherein making the generalized graphical element available for use in a graphic design comprises receiving user inputs directing placement of the generalized graphical element in a graphic design being created by the user and placing the generalized graphical element in accordance with the user inputs, and wherein the generalized graphical element takes on at least one additional visual characteristic based on its placement in the graphic design.

21. The computer readable memory of claim 18, wherein the functions further comprise receiving inputs from the user explicitly assigning at least one visual characteristic to a graphical element and assigning a similar or identical visual characteristic to other graphical elements illustrating similar properties.
